(19) United States
(12) Patent Application Publication
(10) Pub. No.: US 2016/0098119 A1
(43) Pub. Date: Apr. 7, 2016

(54) AUDIO CODEC, PORTABLE ELECTRONIC APPARATUS AND BUTTON CONTROL METHOD

(71) Applicant: REALTEK SEMICONDUCTOR CORP., HSINCHU (TW)

(72) Inventors: Cheng-Pin Chang, Taipei City (TW); Tsung-Peng Chuang, Hsinchu County (TW)

(21) Appl. No.: 14/866,182

(22) Filed: Sep. 25, 2015

(30) Foreign Application Priority Data
Oct. 1, 2014 (TW) 103134227

(51) Int. Cl. G06F 3/044; G06F 3/16

(52) U.S. Cl. CPC G06F 3/044; G06F 3/162; G06F 3/165

(57) ABSTRACT

A button control method for a built-in audio codec of a portable electronic apparatus, and the button control method includes the following steps. A plurality of button signals generated by a button unit is first detected during a button detection period. Next, the button signals are sequentially recorded during the button detection period. The processing unit matches and identifies the button signals provided thereto to generate a control command accordingly to correspondingly control the portable electronic apparatus.

### BACKGROUND

1. Technical Field

The present disclosure relates to a portable electronic apparatus, in particular, to a portable electronic apparatus using an audio codec and a button control method.

2. Description of Related Art

As multimedia, communication, and electronic technologies rapidly advance, people gradually increase their reliance on portable electronic apparatus, such as smart phones, tablets, and PDAs. As such, portable electronic apparatuses have become indispensable for most people in their daily life. While portable electronic apparatuses are becoming indispensable, demands on light-weight, thin, and compact structures as well as multiple functions for the portable electronic apparatuses arise. As a result, a portable electronic apparatus having various multimedia, communication, and photo taking functionalities integrated therein has become a main stream product on the market.

As portable electronic apparatuses continue to incorporate more and more functions, nowadays, people can freely operate their own portable electronic apparatus at any time and any place. Currently, most of the portable electronic apparatuses are operated with an equipped touch display. Practical operating inconveniences have started to arise, such as when the user only has one hand available to control the portable electronic apparatus, or when the user's finger is dirty or wet, or even when the user is wearing a glove, that affect a user's operation of the portable electronic apparatus controlled only by the equipped touch display.

### SUMMARY

An exemplary embodiment of the present disclosure provides a portable electronic apparatus and the portable electronic apparatus includes an audio codec and a processing unit. The audio codec includes a button detector and a register. The processing unit is coupled to the audio codec, and the register is coupled to the button detector. The button detector is operative to detect a plurality of button signals sequentially generated by a button unit during a button detection period. The register is operative to record the button signals in sequence during the button detection period. The processing unit is configured to operatively identify the button signals recorded in the register and generate a control command to correspondingly control the portable electronic apparatus.

An exemplary embodiment of the present disclosure provides a button control method, which is adapted for an audio codec of a portable electronic apparatus. The button control method includes the following steps. A plurality of button signals generated by a button unit during a button detection period is first detected. The button signals being detected during the detection period are recorded in sequence. The button signals being sequentially recorded during the button detection period are provided to a processing unit thereafter for the processing unit to match and identify the button signals recorded and to generate a control command controlling the operation of the portable electronic apparatus.

An exemplary embodiment of the present disclosure provides an audio codec. The audio codec includes a button detector and a register. The register is coupled to the button detector. The button detector is operative to detect a plurality of button signals sequentially generated by a button unit during a button detection period. The register is operative to record the button signals in sequence during the button detection period and provide the button signals detected in sequence to a processing unit for the processing unit to match and identify the button signals and generate a control command, accordingly.

To sum up, exemplary embodiments of the present disclosure provide an audio codec, a button control system and a button control method, which can generate a control command for controlling the operation of an application on a portable electronic apparatus based on the pressing sequence made by a user using at least one button of a button unit on a headset. The user can thus easily operate the portable electronic apparatus even when the user has only one hand for operation or when user's hand is dirty or wet or when wearing glove, thereby greatly enhanced operational convenience with the portable electronic apparatus.

In order to further understand the techniques, means and effects of the present disclosure, the following detailed descriptions and appended drawings are hereby referred to, such that, and through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a diagram of a portable electronic apparatus and a headset provided in accordance to an exemplary embodiment of the present disclosure.

FIG. 2 is a block diagram illustrating a button control system provided in accordance to an exemplary embodiment of the present disclosure.

FIG. 3 is a diagram illustrating an operation of an audio codec receiving button signals provided in accordance to an exemplary embodiment of the present disclosure.

FIG. 4 is a diagram illustrating an operation of an audio codec receiving button signals provided in accordance to another exemplary embodiment of the present disclosure.

FIG. 5 is a flowchart diagram illustrating a button control method provided in accordance to an exemplary embodiment of the present disclosure.

### DESCRIPTION OF THE EXEMPLARY EMBODIMENTS

Reference will now be made in detail to the exemplary embodiments of the present disclosure, examples of which are illustrated in the accompanying drawings. Drawings are provided in the present disclosure to illustrate the general structure of the present disclosure, some sizes of structures or portions in the drawings provided may be exaggerated relative to sizes of other structures or portions for illustration purposes. Wherever possible, the same reference numbers are used in the drawings and the description to refer to the same or like parts.

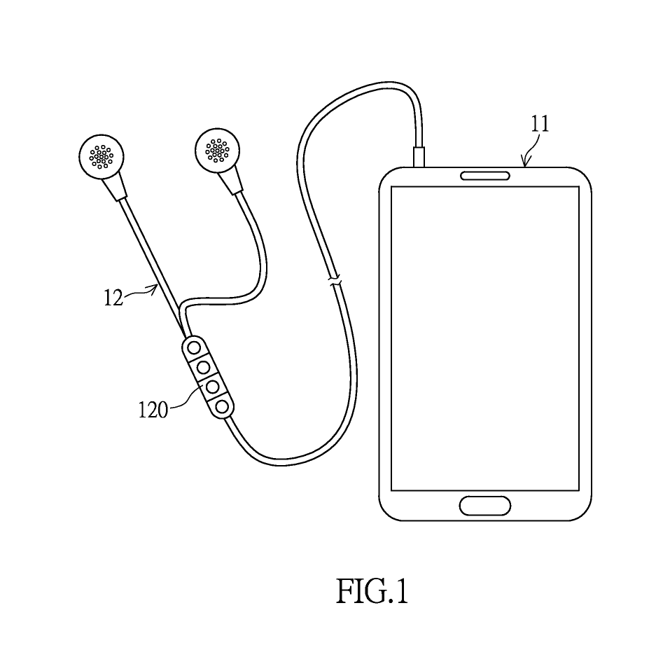

Please refer to FIG. 1, which shows a diagram illustrating a portable electronic apparatus and a headset provided in accordance to an exemplary embodiment of the present disclosure. Particularly, FIG. 1 shows a portable electronic apparatus 11 and a headset 12 having a button unit 120. The button unit 120 has a plurality of buttons as shown in FIG. 1. In the instant embodiment, the portable electronic apparatus 11 is operable to provide a user with functions including multimedia playback, communication, and photo-shooting as well as running various application programs. The user can connect or link the headset 12 to the portable electronic apparatus 11 and operate the portable electronic apparatus 11 (e.g., music playback control, phone dialing and answering operation and/or volume control) with the buttons of the button unit 120 provided. It is worth to note that in the instant embodiment, four buttons were used for illustration only, and the exact number of buttons used can be configured to be two, three, four or more than four based on the operational needs, and the present disclosure is not limited thereto.

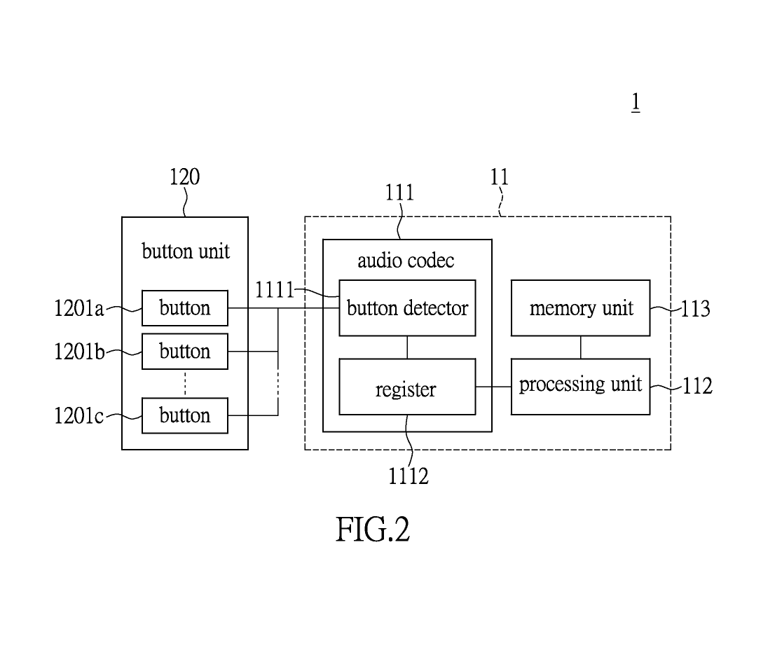

Next, details on the implementations of how to generate various control commands using the button unit 120 are provided in the following paragraphs. Please refer to FIG. 2, which shows a block diagram illustrating a button control system provided in accordance to an exemplary embodiment of present disclosure. A button control system 1 includes the portable electronic apparatus 11 and the button unit 120. The button unit 120 in the instant embodiment is implemented by a plurality of buttons disposed on the headset 12. The portable electronic apparatus 11 includes an audio codec 111, a processing unit 112, and a memory unit 113. The button unit 120 includes a button 1201a, a button 1201b, and a button 1201c. The audio codec 111 includes a button detector 1111 and a register 1112. The buttons 1201a, 1201b, and 1201c are respectively coupled to the button detector 1111. The button detector 1111 is coupled to the register 1112. The processing unit 112 is coupled to the register 1112. The memory unit 113 is coupled to the processing unit 112.

Please refer to FIG. 1 in conjunction with FIG. 2. The button unit 120 is the control element of the headset 12. Specifically, when the earphone connector (not shown) of the headset 12 connects to the portable electronic apparatus 11, the user can operate the portable electronic apparatus 11 by operating the buttons 1201a, 1201b, and 1201c of the button unit 120. In the instant embodiment, buttons 1201a, 1201b, and 1201c of the button unit 120 are implemented by resistive buttons. When the user presses any one of the buttons 1201a, 1201b, and 1201c, the button unit 120 operatively generates a button signal corresponding to the respective button pressed and transmits a control command accordingly to the portable electronic apparatus 11 thereafter. More specifically, the button signals generated by each of the buttons 1201a, 1201b, and 1201c are different and vary based on the resistance of each button, i.e., the voltage signals generated by each button are different such that the audio codec 111 of the button unit 120 can identify each respective button signal. The buttons of the button unit 120 of the instant embodiment are illustrated with resistive buttons, however in other embodiment, the buttons of the button unit 120 also can be implemented by other circuitries capable of generating the button signals, such as capacitive buttons and comparators and the present disclosure is not limited thereto.

The portable electronic apparatus 11 is an electronic apparatus having an earphone jack (e.g., 2.5 mm or 3.5 mm jack) including but not limited to a smart phone, a tablet or a laptop. The audio codec 111 includes a digital to analog converter and an analog to digital converter and the audio codec 111 is operable to convert an analog voice signal to a binary digital signal with the analog to digital converter thereof.

The button detector 1111 is comprised of the necessary circuitries, necessary logics, or necessary codes for operatively detecting the button signal generated by the button unit 120. That is, when any of the buttons 1201a, 1201b, and 1201c has been pressed, the button detector 1111 operatively detects the button signal generated by the respective button and identifies which button has been pressed. To put it concretely, the audio codec 111 identifies the button (e.g., the button 1201a, 1201b, or 1201c) being pressed by the user based on the voltage signal generated by the respective button.

The register 1112 is comprised of the necessary circuitries, necessary logics, or necessary codes for sequentially recording the button signals detected. Particularly, the register 1112 sequentially records a group of button signals. It is worth to note that after the register 1112 finishes recording the button signals detected, the audio codec 111 operatively issues an interrupt request signal to request the processing unit 112 to read the data (e.g., the pressing sequence associated with the button signals) recorded in the register 1112. In one embodiment, the processing unit 112 may read the data recorded in the register 1112 using a polling technique. The present disclosure does not limit the exact method used by the processing unit 112 for accessing and read the register 1112.

The processing unit 112 is the operational core of the portable electronic apparatus 11. The processing unit 112 may be any circuit component having data processing capability including but not limited to a central processing unit (CPU) and a micro-controller (MCU). The processing unit 112 reads a group of button signals recorded in the register 1112, matches and identifies the pressing sequence associated with the button signals detected against a look-up table, and obtains a control command corresponding to the pressing sequence associated with the group of button signals detected. The look-up table records the pressing sequence of the buttons and the respective control command. It is worth to note that the connection interface of the audio codec 111 connecting the processing unit 112 may be an I²C interface or any other equivalent data transmission interface and the present disclosure is not limited thereto.

The memory unit 113 is comprised of the necessary circuitries, necessary logics, or necessary codes for operatively storing application programs, execution data, and the look-up table. The memory unit 113 can be implemented by a volatile memory chip or a nonvolatile memory chip including but not limited to a flash memory chip and a read-only memory chip.

Accordingly, the audio codec 111 having the button detector 1111 and the register 1112 can enable the user to operate the portable electronic apparatus 11 by using the pressing sequence made with buttons 1201a, 1201b, and 1201c.

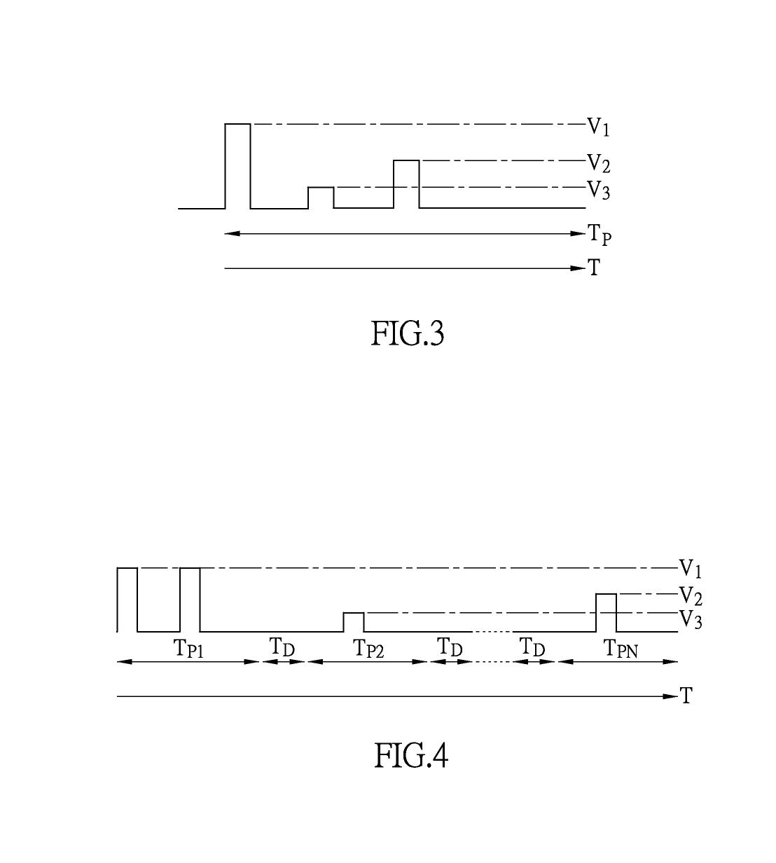

Next, descriptions regarding practical application of the present disclosure are provided in the following paragraphs. Please refer to FIG. 3 in conjunction with FIG. 2. FIG. 3 shows a diagram illustrating an operation of an audio codec receiving the button signals provided in accordance to an exemplary embodiment of the present disclosure. In the instant embodiment, the button detector 1111 detects the buttons signals V₁, V₃, and V₂, which are sequentially generated by the buttons 1201a, 1201b, and 1201c during a button detection period T_{P}. The register 1112 records the button signals V₁, V₃, and V₂ detected by the button detector 1111 in sequence during the button detection period T_{P}. The button signals detected during the button detection period T_{P} form a group of button signals ordered based on the detecting sequence or the generation sequence of the button signals. The button detection period T_{P} (represented by T in FIG. 3) is the time period (e.g., 1500 ms) counted after the detection of the first button signal (e.g., the button signal V1).

In one embodiment, the user may predefine a plurality of control commands in the look-up table, and each control command corresponds to a specified pressing sequence (e.g., the pressing sequence listed in Table 1). More specifically, after the user presses the buttons 1201a, 1201c, and 1201b in the order shown in FIG. 3, the processing unit 112 reads from the register 1112 thereafter for the pressing sequence, generates the control command (i.e., the screen unlock command) corresponding to the pressing sequence using the look-up table, and causes the portable electronic apparatus 11 to perform the screen unlocking operation.

TABLE 1

| Pressing Sequence | Control Command |
|---|---|
| button 1201a=> button 1201c=> button 1201b | Screen unlock |
| button 1201b=> button 1201a=> button 1201c | Initiate camera |
| | application |
| button 1201c=> button 1201a=> button 1201b | Call Mr. Wang |
| button 1201b=> button 1201c=> button 1201a | Turn on the Radio |

Next, please refer to FIG. 4 in conjunction with FIG. 2. FIG. 4 shows a diagram illustrating an operation of an audio codec receiving button signals provided in accordance to another exemplary embodiment of the present disclosure. The embodiment illustrated by FIG. 4 differs from the embodiment illustrated by FIG. 3 in the button detection method used. As shown in FIG. 4, the button detector 1111 can detect the button pressing operation with multiple button detection periods T_{P1}, T_{P2}, T_{PN} so as to detect whether a button has been pressed during each button detection period as well as the pressing number of the respective button. There exists a time interval T_{D} between two adjacent button detection periods, i.e., any two adjacent button detection periods are spaced apart by the time interval.

For instance, the button detector 1111 operatively starts counting the button detection period T_{P1} upon detecting the button signal V₁ corresponding to the button 1201 a and continues to detect the occurrence of the button signal V₁. The register 1112 at the same time records the number of times that the button signal V₁ is generated (i.e., the pressing number of the button 1201a). Similarly, after the time interval T_{D} has elapsed, the button detector 1111 starts counting the button detection period T_{P2} upon detecting the button signal V₃ corresponding to the button 1201b and continues to detect the occurrence of the button signal V₃. The register 1112 at the same time records the number of times that the button signal V₃ is generated (i.e., the pressing number of the button 1201b). Likewise, after another time interval T_{D} has elapsed, the button detector 1111 starts counting the button detection period T_{P3} upon detecting the button signal V₂ corresponding to the button 1201c and continues to detect the occurrence of the button signal V₂. The register 1112 at the same time records the number of times that the button signal V₂ has been generated (i.e., the pressing number of the button 1201c), and so on. It is worth to note that the duration of the button detection periods may be configured according to the number of buttons 1201a, 1201b, and 1201c used.

In one embodiment, the user may generate or produce inputs of 0, 1, 2, 3˜9 using buttons 1201a, 1201b, and 1201c. More specifically, the user may predefine the relationship between the pressing number of each button and the input number in the look-up table (e.g., Table 2), such that when the buttons of the button unit 120 are pressed in the order depicted in FIG. 4, the register 1112 will sequentially record the number of times that the button signal V₁ is generated to be 2, the number of times that the button signal V₃ is generated to be 1, and the number of times that the button signal V₂ is generated to be 1. The processing unit 112 thus can match and identify the set of number of 247 using Table 2. The input method depicted by FIG. 4 may be configured and used to input a security code for a cell phone or input a speed dial number for calling operation, and the present disclosure is not limited thereto.

TABLE 2

Pressing
number

| | 1 | 2 | 3 | 4 |
|---|---|---|---|---|
| Button 1201a | 1 | 2 | 3 | |
| Button 1201b | 4 | 5 | 6 | |
| Button 1201c | 7 | 8 | 9 | 0 |

It is worth noting that the button detection period or button functions may be configured based on the need or the operation habits of the user. Using the aforementioned button control system disclosed can enhance the user's operational convenience with the portable electronic apparatus.

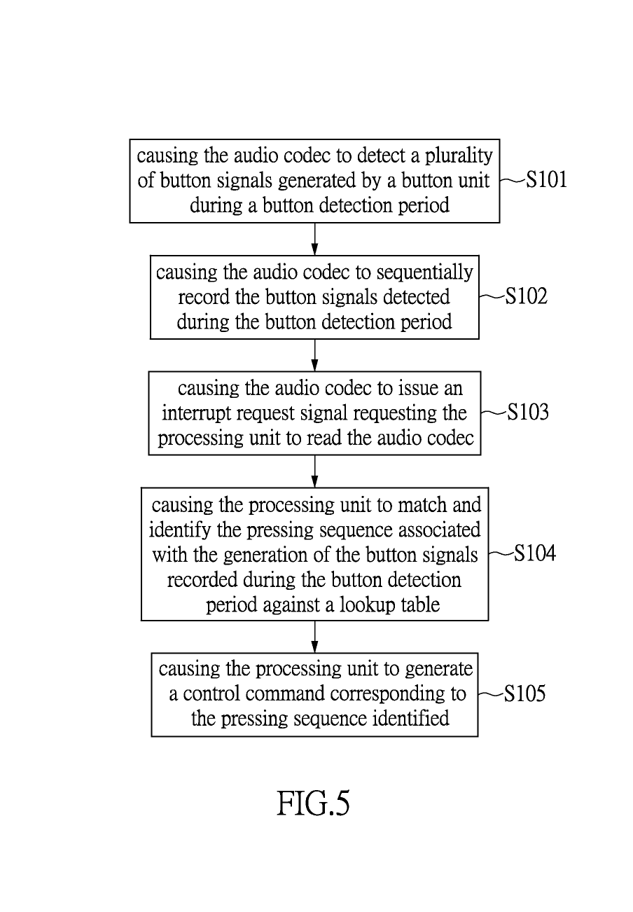

The present disclosure further provides a button control method. Please refer to FIG. 5 in conjunction with FIG. 1 and FIG. 2. FIG. 5 shows a flow chart diagram illustrating a button control method provided in accordance to an exemplary embodiment of the present disclosure. The button control method used when the headset 12 connects to the portable electronic apparatus 11 includes the following steps. In Step S101, the audio codec 111 detects a plurality of button signals during a button detection period. In Step S102, the audio codec 111 sequentially records the button signals detected during the button detection period. In Step S103, the audio codec 111 issues an interrupt request signal requesting the processing unit 112 to read the audio codec 111. In Step S104, the processing unit 112 matches and identifies the pressing sequence associated with the button signals recorded during the button detection period against the look-up table. In Step S105, the processing unit 112 generates a control command accordingly using the look-up table.

Please refer to FIG. 2 in conjunction with FIG. 5. In Step S101, the audio codec 111 detects the button signals generated by the buttons 1201a, 1201b, and 1201c of the button unit 120 using the button detector 1111. In Step S102, the audio codec 111 uses the register 1112 to record the button signals detected sequentially during the button detection period. Particularly, the register 1112 records a group of button signals.

In Step S103, the audio codec 111 issues the interrupt request signal to the processing unit 112 requesting the processing unit 112 to access or read the register 1112. More specifically, in Step S104, the processing unit 112 reads the group of button signals recorded by the register 1112 and compares the pressing sequence associated with the button signals detected with the look-up table. In Step S105, the processing unit 112 obtains the control command corresponding to the pressing sequence and controls the operation of the portable electronic apparatus 11, accordingly.

In summary, exemplary embodiments of the present disclosure provide an audio codec, a button control system and a button control method, which can generate a control command for controlling the operation of an application on a portable electronic apparatus based on the pressing sequence made by a user using at least one button of a button unit on a headset. The user thus can easily operate the portable electronic apparatus even when the user has only one hand for operation or when user's hand is dirty or wet or when wearing a glove, thereby greatly enhancing the user's operational convenience with the portable electronic apparatus.

It is worth to note that the audio codec, a button control system and a button control method disclosed can further serve as a security and safety mechanism. The audio codec, a button control system and a button control method disclosed can use the pressing sequence of the buttons to generate an input to the security code of the portable electronic apparatus.

The above-mentioned descriptions represent merely the exemplary embodiment of the present disclosure, without any intention to limit the scope of the present disclosure thereto. Various equivalent changes, alterations or modifications based on the claims of present disclosure are all consequently viewed as being embraced by the scope of the present disclosure.

What is claimed is:

1. A portable electronic apparatus, comprising:
an audio codec comprising:
a button detector, operative to sequentially detect a plurality of button signals generated by a button unit during a button detection period;
a register coupled to the button detector, operative to sequentially record the button signals during the button detection period; and
a processing unit coupled to the audio codec, configured to operatively identify the button signals recorded in the register and generate a control command accordingly to correspondingly control the portable electronic apparatus.

2. The portable electronic apparatus according to claim 1, wherein the audio codec issues an interrupt request signal requesting the processing unit to read the register, and the register has the button signals recorded therein.

3. The portable electronic apparatus according to claim 1, wherein the processing unit operatively compares the pressing sequence associated with the button signals recorded in the register during the button detection period against a look-up table to identify the button signals in sequence, and the processing unit generates the control command thereafter accordingly.

4. The portable electronic apparatus according to claim 1, wherein the button unit is located on a headset and the button unit comprises at least one button.

5. The portable electronic apparatus according to claim 1, wherein the button signals are generated according to a pressing sequence of a plurality of buttons in the button unit.

6. A button control method for an audio codec of a portable electronic apparatus, the button control method comprising:
detecting a plurality of button signals generated by a button unit during a button detection period;
recording the button signals detected during the detection period, sequentially; and
providing the button signals sequentially recorded during the button detection period to a processing unit for the processing unit to match and identify the button signals recorded and to generate a control command controlling the operation of the portable electronic apparatus.

7. The button control method according to claim 6, wherein the button detection period is the time period counted after the button unit generates the first button signal.

8. The button control method according to claim 6, wherein the button signals are generated based on the pressing sequence of the plurality of buttons of the button unit on a headset.

9. The button control method according to claim 6, wherein the step of detecting the button signals generated by the button unit during a button detection period comprises of detecting the number of times that the button signal is generated by any respective button in the button unit during a first button detection period and a second button detection period of the button detection period, wherein the first button period and the second button period are spaced apart by a time interval.

10. The button control method according to claim 6, wherein the step of the processing unit matching and identifying the button signals further comprises:
causing the audio codec to issue an interrupt request signal requesting the processing unit to read the button signals recorded in the register.

11. The button control method according to claim 10, wherein after the step of causing the audio codec to issue the interrupt request signal requesting the processing unit to read the button signals recorded in the register, the processing unit operatively compares the pressing sequence associated with the button signals recorded in the register during the button detection period against a look-up table to identify the button signals in sequence, and the processing unit generates the control command thereafter accordingly.

12. An audio codec, comprising:
a button detector, operative to sequentially detect a plurality of button signals generated by a button unit during a button detection period; and
a register coupled to the button detector, operative to record the button signals sequentially during the button detection period and to provide the button signals detected in sequence to a processing unit for the processing unit to identify and generate a control command, accordingly.

13. The audio codec according to claim 12, wherein the audio codec operatively issues an interrupt request signal requesting the processing unit to read the register while the register having the button signals recorded therein.

14. The audio codec according to claim 12, wherein the button unit is located on a headset and the button unit has at least one button.
